(19) United States
(12) Patent Application Publication
(10) Pub. No.: US 2024/0329666 A1
(43) Pub. Date: Oct. 3, 2024

(54) APPARATUS FOR HOLDING A DISPLAY SCREEN

(71) Applicant: Sony Interactive Entertainment Inc., Tokyo (JP)

(72) Inventors: Oliver Hume, London (GB); Jason Craig Millson, London (GB); Carl Pryke, London (GB)

(73) Assignee: Sony Interactive Entertainment Inc., Tokyo (JP)

(21) Appl. No.: 18/612,044

(22) Filed: Mar. 21, 2024

(30) Foreign Application Priority Data
Mar. 29, 2023 (GB) 2304617.0

(51) Int. Cl. G05D 3/12; G06F 3/01; G06V 40/16; G06V 40/19

(52) U.S. Cl. CPC G05D 3/12; G06F 3/012; G06F 3/013; G06V 40/166; G06V 40/19

(57) ABSTRACT

An apparatus for holding a display screen, the apparatus includes reception circuitry to receive, from at least one location-tracking device, location information indicative of a location of a viewer; position-tracking circuitry responsive to the location information to determine a relative position of the viewer relative to the display screen, viewing-region-checking circuitry to determine whether the relative position of the viewer is within a predetermined viewing region, and adjustment control circuitry responsive to the viewing-region-checking circuitry determining that the relative position of the viewer is outside of the predetermined viewing region to control adjustment circuitry to adjust the position and/or orientation of the display screen to place the relative position of the viewer in the predetermined viewing region.

### BACKGROUND OF THE INVENTION

### Field of the invention

The present technique relates to the field of three-dimensional (3D) displays.

3D displays, which display images that appear-to a viewer-to be three-dimensional, are becoming increasingly popular for a wide range of uses. Such displays may be used for displaying films and television programs, for playing games, and for graphic design (e.g. allowing a designer to view a design from multiple angles). It would be advantageous to improve the experience of using a 3D display.

### SUMMARY OF THE INVENTION

In a first example of the present technique, there is provided an apparatus of claim 1.

In another example of the present technique, there is provided a method of claim 13.

In another example of the present technique, there is provided a computer program of claim 14.

Further respective aspects and features of the invention are defined in the appended claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a spatial reality display;

FIG. 2 illustrates examples of a display screen and a location-tracking device;

FIG. 3 illustrates a predetermined viewing region;

FIGS. 4 to 8 illustrate an apparatus holding a display screen;

FIG. 9 illustrates circuitry of an apparatus for holding a display screen; and

FIG. 10 is a flow diagram illustrating a method of operating an apparatus for holding a display screen.

For clarity of illustration, elements illustrated in the figures have not necessarily been drawn to scale. Further, where considered appropriate, reference numerals have been repeated among the figures to indicate corresponding or analogous elements.

### DESCRIPTION OF THE EMBODIMENTS

Methods and systems are disclosed for holding a display screen. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

In the present application, the words “comprising at least one of . . . ” are used to mean that any one of the following options or any combination of the following options is included. For example, “at least one of: A; B and C” is intended to mean A or B or C or any combination of A, B and C (e.g. A and B or A and C or B and C).

### Spatial Reality Displays

Generally, the expression “3D display” is used to describe the display of images that appear, to a viewer, to occupy three dimensions. For example, a 3D display may give the illusion of depth, even if the image is displayed on a flat (two-dimensional, 2D) display surface-for example, this can make the image appear 3D to a stationary viewer. The perception of depth can be achieved by providing a different image to each of a viewer's eyes-for example, by the viewer wearing glasses which separate out two images (e.g. using colour filters or polarising filters), providing a separate display screen for each eye (such as in a head-mounted display (HMD) apparatus), or by controlling the direction with which light is emitted by the display screen (e.g. using microlenses on the surface of the display screen).

A 3D display may instead (or in addition) be arranged to adjust a displayed image as the viewer moves their head and/or eyes, to give the viewer the illusion of being able to look around (or even behind) objects-this makes the image appear 3D to a moving viewer. This effect is known as “parallax”, and a display which provides this effect may be known as a “spatial reality” display screen. A spatial reality display screen may additionally employ techniques described above for providing the perception of depth, so that the displayed image appears 3D regardless of whether the viewer is stationary or moving.

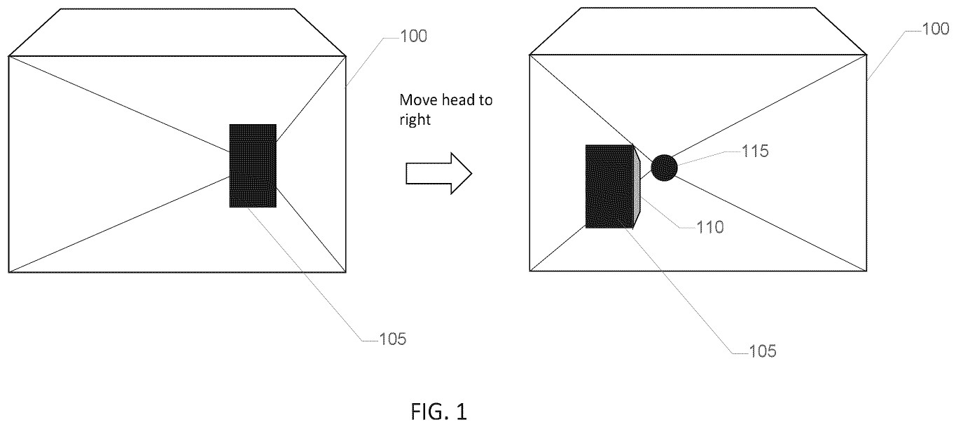

FIG. 1 illustrates the effect provided by a spatial reality display. In particular, FIG. 1 shows how an image displayed on a spatial reality display screen 100 can be adjusted as a viewer moves their head to the right (i.e. the direction of the arrow). As shown in the figure, the position of the rectangular object 105 has changed, so that it now appears further to the left of the screen. In addition, the side 110 of the rectangle is also shown in the second image, giving the viewer the perception of moving around the object. In addition, a circular object 115 has become visible in the second image, giving the viewer the perception of being able to see behind the rectangular object 105. This creates a parallax effect, that makes an image-even an image presented on a 2D display surface-appear 3D as a viewer moves their head relative to the screen. Optionally the parallax effect is not just for left-right movement as illustrated in FIG. 1 but also for up-down movement.

Providing the illusion of parallax in this way generally involves determining the viewer's position relative to the display screen, and adjusting the displayed image as the viewer's position changes. There are multiple ways of determining a viewer's position relative to the display screen, each of which may involve some form of location-tracking device recording location information, and providing this to position-tracking circuitry which is capable of processing the location information to determine the position of the viewer relative to the display screen.

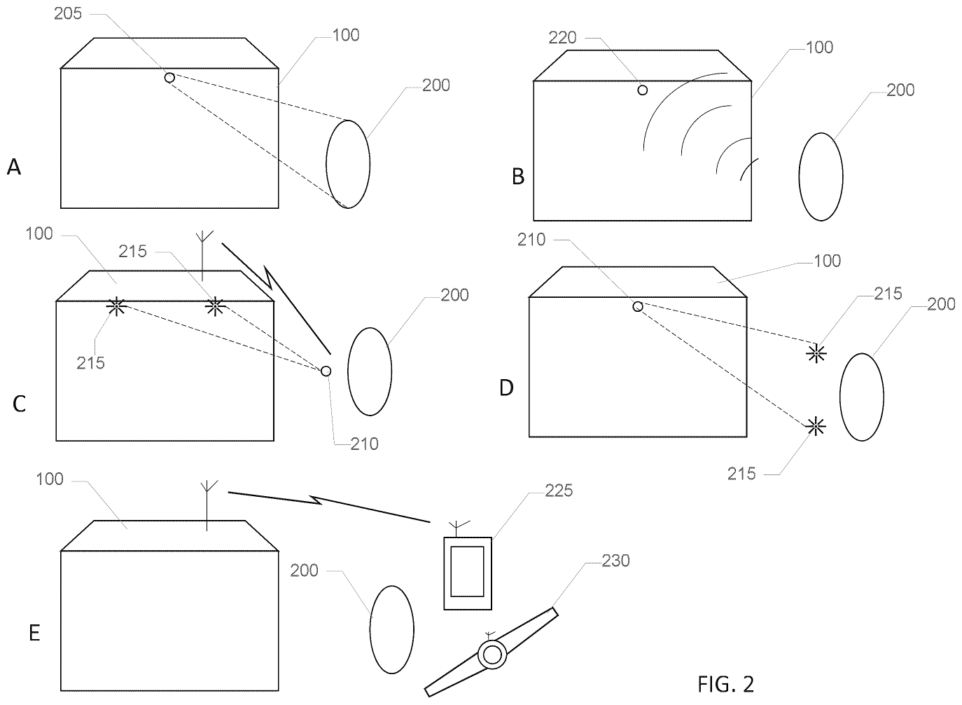

FIG. 2 shows a number of examples of location-tracking devices (also referred to herein as “tracking devices”) for tracking the position of a viewer 200 relative to the display screen 100.

For example, part “A” of FIG. 2 shows an example in which the location-tracking device is a camera 205 provided on or attached to the display screen 100. The camera 205 records images of the viewer and their surroundings, and these images can be processed—e.g. by applying a head-tracking or eye-tracking process—to determine the relative location of the viewer. In this example, the camera 205 is a location-tracking device, and the images recorded by the camera are location information. Using head-tracking or eye-tracking can be particularly advantageous, because it makes it possible to provide the illusion of parallax without the viewer needing to wear 3D glasses, or any other specialised equipment or clothing. The camera 205 may optionally be stereoscopic or use infra-red or ultrasound distance measurement to assist with determining distance to the viewer.

A similar approach is used in part “D” of FIG. 2, where an infrared camera 210 is provided. In this case, the user is provided with two infrared light sources 215 spaced apart by a predetermined separation (e.g. these could be installed on an object held or worn by the user, such as an item of clothing, glasses or a controller), and the infrared camera 210 is configured to detect and record images of the infrared light sources. The recorded images can then be processed to determine the relative position of the viewer (e.g. based on the position and separation of the infrared light sources in the images). In this example, the camera 210 is a location-tracking device, and the images recorded by the camera are location information.

Part “C” of FIG. 2 also makes use of an infrared camera 210 and two infrared light sources 215, except in this case their positions are reversed—the infrared light sources 215 are integrated with or attached to the display screen 100, while the infrared camera 210 is held or worn by the viewer. In this case, the camera transfers data (e.g. recorded images or positions of the light sources within the captured images) to the display screen—for example, part “C” shows a wireless connection; however, the connection could instead be wired. In this example, the camera 210 is a location-tracking device, and the images recorded by the camera are location information.

While the location-tracking devices in parts “A”, “C” and “D” of FIG. 2 make use of light (either visible light or infrared light) to track the location of the viewer, other techniques involve recording audio. For example, “B” shows a display screen with an integrated/attached microphone 220. The microphone 220 records audio data, and this can be processed to determine the viewer's relative position. For example, the sound of a viewer's voice may become louder as they move towards the microphone, or the sounds of the surroundings may become muffled, and this can be used to deduce the viewer's position. In this example, the microphone 220 is a location-tracking device, and the audio recorded by the microphone is location information.

Finally, “E” shows an example in which the location-tracking device comprises an object worn or held be a user—e.g. a smartphone 225 or a smartwatch 230. The handheld or wearable device 225, 230 transmits the location information to the display screen—for example, the location information could be GPS or other satellite navigation data obtained by the handheld/wearable device, gyroscope readings from the device, and/or data recorded by a camera or microphone of the device.

The location-tracking devices in each of these examples provide location information which can be used to determine a relative position of the viewer 200 relative to the display screen 100. As described above, this information can be used to generate the image displayed on the display screen (for example, to give the illusion of parallax, as shown in FIG. 1). However, as discussed below, the relative position of the viewer can instead (or in addition) be used to determine whether the viewer is in a predetermined viewing region.

### Sweet Spot

One potential problem with 3D displays (including spatial reality displays) is that if a viewer moves too far in any given direction the illusion (e.g. the illusion of depth and/or parallax) may break. For example, there may be a region known as the “sweet spot” or “sweet zone/region” (referred to herein as a predetermined viewing region) within which the illusion works (e.g. a viewer in this region perceives an image displayed by the display screen as a 3D image). This predetermined viewing region may be dependent on the location-tracking device(s) which are provided for tracking the location of the viewer—for example, the location-tracking device(s) may only be able to track a viewer within a given region of space, and hence the predetermined viewing region may be limited to this region. The predetermined viewing region may alternatively (or in addition) be dependent on the technique used for providing the 3D illusion—for example, for some techniques, the 3D illusion may not work when viewing the display screen from certain extreme angles. Another constraint on the predetermined viewing region may simply be due to the fact that the display screen may have a flat surface that cannot be seen from certain angles (for example, the screen may not be visible from behind). Indeed, this constraint can also apply to 2D displays.

Hence, the predetermined viewing region can be considered to be a region within which an image displayed on the screen satisfies a given condition (e.g. providing a 3D illusion such as the illusion of depth and/or the illusion of parallax, or simply the image being viewable) when viewed by the viewer positioned in the predetermined viewing region. Alternatively, or in addition, the predetermined viewing region can be considered to be a region within which the at least one location-tracking device is capable of tracking the viewer. Alternatively, or in addition, the predetermined viewing region can be considered to be a region from which an displayed image displayed on the screen is visible.

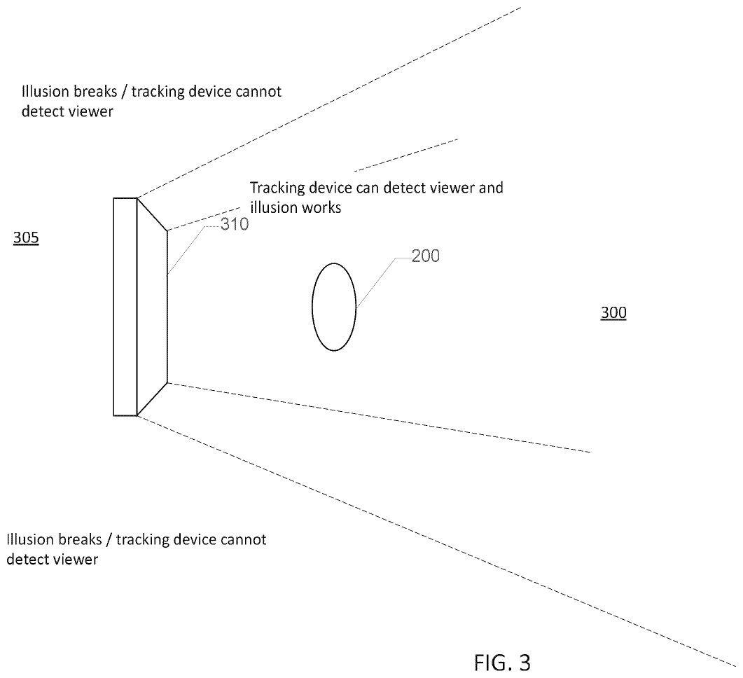

FIG. 3 illustrates an example of a predetermined viewing region 300 for a 3D display screen 310. Within the viewing region 305, the viewer 200 experiences the illusion of depth and/or parallax when viewing the 3D display screen 310 (which may, for example, be a spatial reality display screen). Outside 305 of the predetermined viewing region, the illusion is broken.

The predetermined viewing region can be defined using coordinates (e.g. Cartesian or polar coordinates), for example relative to the display screen 310. The display screen 310 or an associated apparatus (such as the apparatus for holding the viewing screen, described below) may comprise processing circuitry (such as a central processing unit) for determining the predetermined viewing region. Alternatively, because the predetermined viewing region may be fixed for a given display screen (e.g. if the location-tracking device is in a position that is fixed relative to the display screen), the display screen or apparatus for holding the display screen may instead comprise storage circuitry that is pre-programmed (e.g. at the time of manufacture) to hold information identifying the predetermined region.

### Apparatus for Holding the Display Screen

The present technique aims to improve the viewer's experience of using a display screen such as a 3D display screen by addressing the shortcomings associated with the predetermined viewing region or sweet zone. In particular, the present technique provides an apparatus 400 for holding a display screen 420. The display screen 420 could, for example, be a 3D display such as a spatial reality display screen. However, in some examples the display screen 420 may be a 2D display screen. The apparatus 400 comprises an adjustment mechanism 405 which moves the display screen in response to detecting that the viewer has moved. In this way, the relative position of the viewer can be kept within the predetermined viewing region of the display screen.

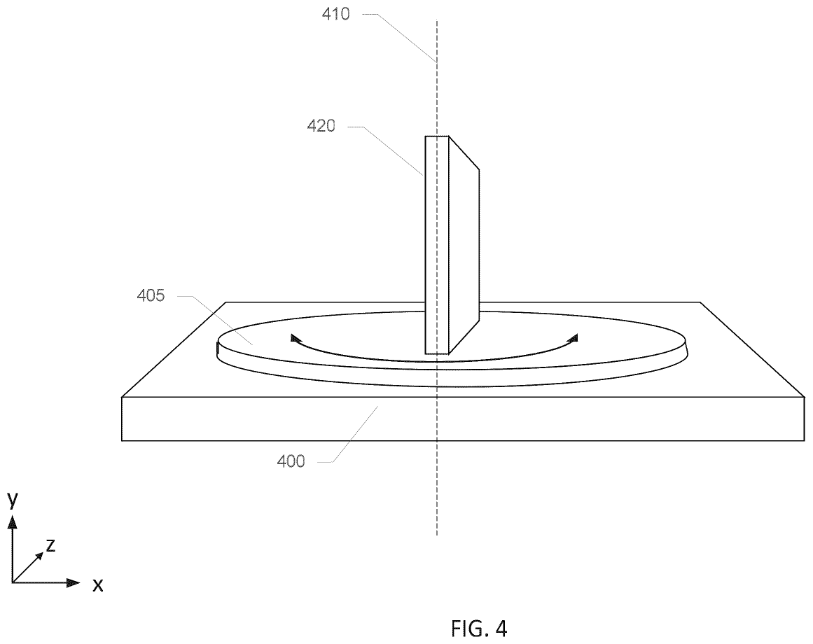

FIGS. 4 to 7 show examples of how the display screen 420 can be moved. In the examples shown in FIGS. 4 to 7, the adjustment mechanism is a turntable 405, but it will be appreciated that this is just one example of an adjustment mechanism.

As shown in FIGS. 4, 5 and 6, the turntable 405 may be arranged to rotated about multiple axes. FIG. 4 shows rotation about a first axis 410 (e.g. the axis labelled as the y-axis in FIG. 4)—this might be implemented by installing a motor (not shown) to turn the turntable 405 in the direction shown by the arrows. The first axis 410 might also be considered to be the “yaw” axis.

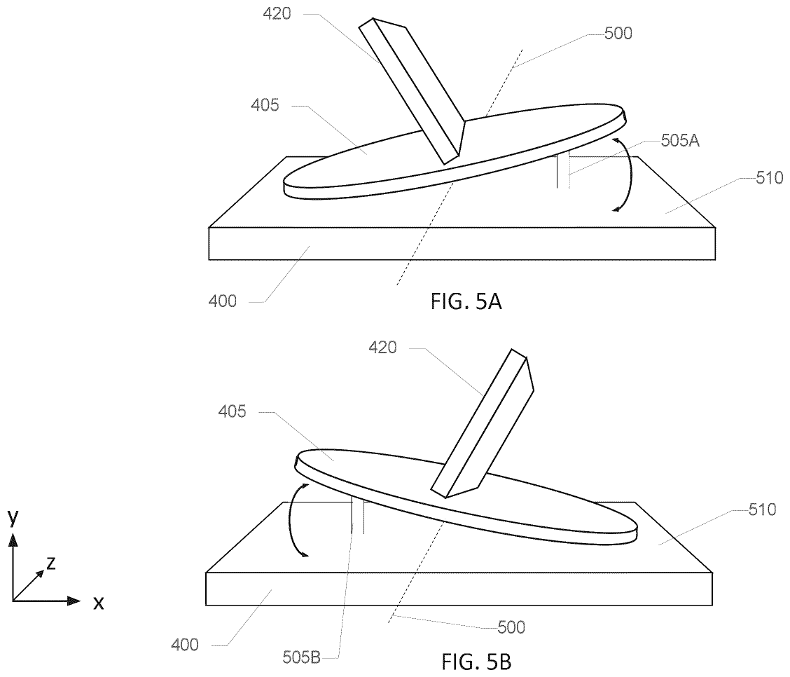

FIGS. 5A and 5B show rotation about a second axis 500 (e.g. the z-axis or “pitch” axis). This may be implemented using a pair of supports 505A, 505B, each of which extends outwards from the surface 510 of the apparatus to raise one side of the turntable 405. The supports may comprise a wheel, roller, or bearing at the supporting end to facilitate continued rotation of the turntable whilst it is tilted.

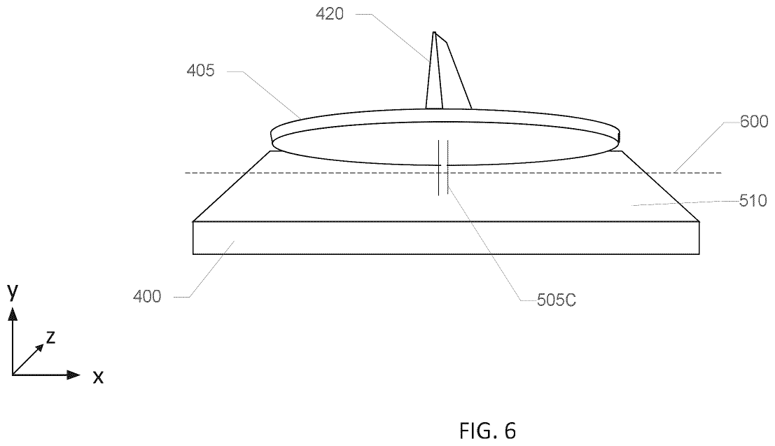

FIG. 6 shows rotation about a third axis 600 (the x-axis or “roll” axis). This may be implemented using a further pair of supports, of which only one 505C is visible (the other being hidden behind it), which operate in the same way as the supports 505A, 505B shown in FIGS. 5A and 5B and again may comprise a rotational element at the support end to allow the turntable to rotate as needed.

Alternatively to the supports, the turntable may have a curved underside (e.g. hemispherical or a smaller spherical section such as a spherical cap), with actuators similar to that driving rotation driving a tilt of the underside of the turntable.

In any event, the turntable 405 is an example of adjustment circuitry, and in particular-when the turntable 405 is capable of providing rotation about at least one of the three axes 410, 500, 600-can be considered to be an example of rotation circuitry to adjust the orientation of the display screen by rotating the display screen about one or more axes of rotation.

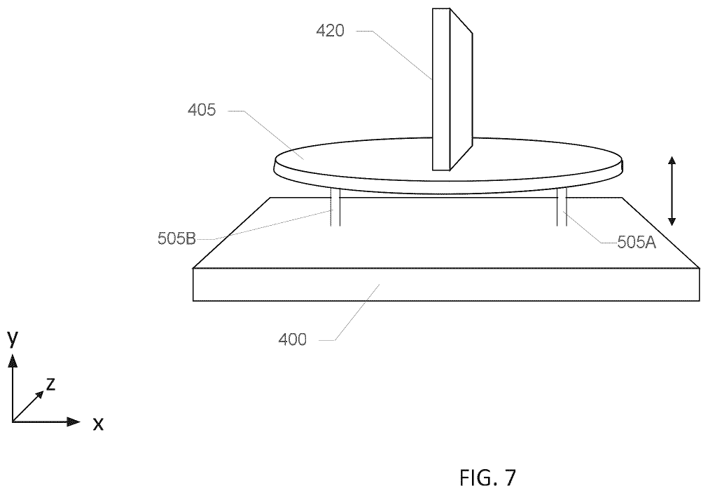

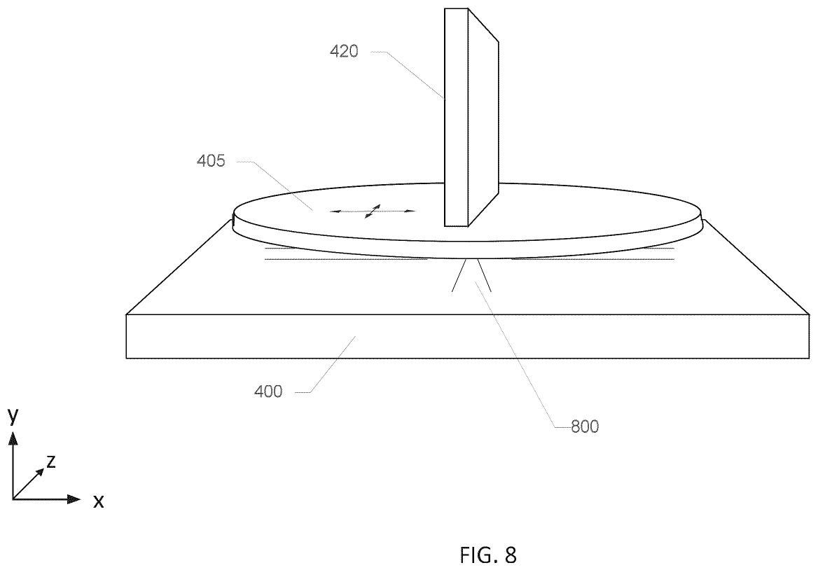

FIGS. 7 and 8 illustrate examples of how the turntable 405 can be translated (moved) along each of the x-, y- and z-axes. For example, FIG. 7 illustrates translation of the turntable 405 up and down along the y-axis (i.e. the first axis 410 as illustrated in FIG. 4). This may be implemented using the same supports 505A, 505B as shown in FIGS. 5A and 5B (and/or those shown in FIG. 6).

FIG. 8 illustrates how the turntable 405 can be translated (moved) along the x-and z-axes (the second and third axes 500, 600 shown in FIGS. 5 and 6). This may be implemented using tracks or grooves 800 along which the turntable can move.

When the turntable is capable of providing translation along at least one of the three axes 410, 500, 600, it can be considered to be an example of translation circuitry to adjust the position of the display screen. Hence, the turntable 405 can be an example of one or both of rotation circuitry and translation circuitry.

It will be appreciated that some implementations may only provide some of the degrees of motion shown in these figures—rotation or translation about or along just one axis will still provide an improved viewing experience, by increasing the area/range of space which can be kept within the predetermined viewing region. However, it will be appreciated that providing a greater range of movement about a greater number of axes will provide a greater improvement.

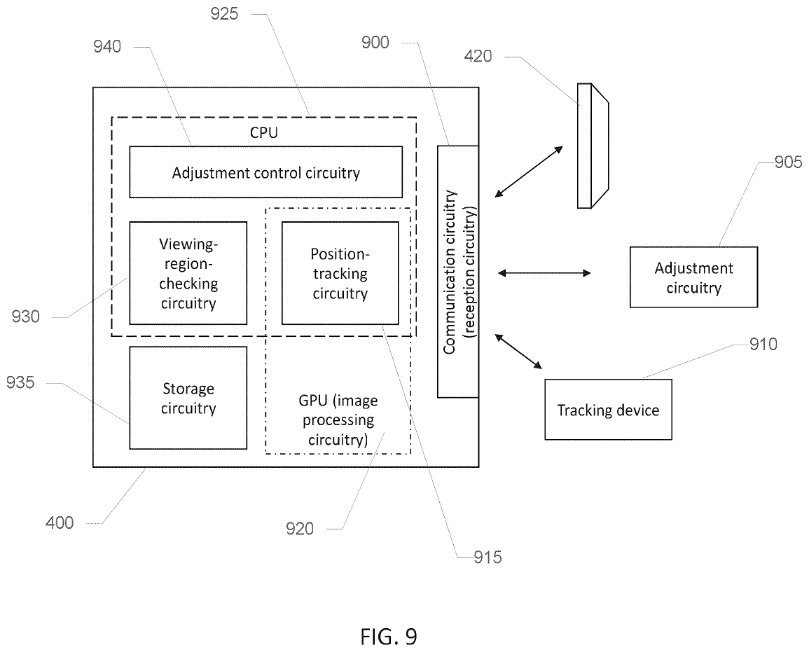

As suggested above, the adjustment mechanism (e.g. the turntable 405) can be used to adjust the position of the display screen to keep the viewer within the predetermined viewing region (“sweet spot”). For example, as shown in FIG. 9, the apparatus 400 may comprise communication circuitry 900 to communicate with the adjustment circuitry 905 (e.g. the turntable 405), a location-tracking device 910 (which could be one of the location-tracking devices shown in FIG. 2) and, optionally, the display screen (for example if the apparatus is also responsible for generating images to display on the display screen. In particular, the communication circuitry 900 is capable of receiving, from the location-tracking device (also referred to as a tracking device), location information indicative of a position of a viewer in space. Hence, the communication circuitry 900 is an example of reception circuitry to receive, from at least one location-tracking device, location information indicative of a location of a viewer.

The communication circuitry 900 then provides the location information to position-tracking circuitry 915, which processes the location information to determine a relative position of the viewer relative to the display screen 420. The position-tracking circuitry 915 is, therefore, an example of position-tracking circuitry responsive to the location information to determine a relative position of the viewer relative to the display screen. Note that the location information need not necessarily specify the location of the viewer directly-instead, it can be any information from which the viewer's location can be derived. For example, if the location information comprises image data recorded (captured) by a camera (e.g. if the location-tracking device 910 comprises at least one camera), the position-tracking circuitry may comprise image processing circuitry to perform an object recognition process (such as facial recognition) to identify a given object (e.g. the viewer's face) within the image, and then to perform object tracking (e.g. head-and/or eye-tracking) to determine the relative position of the viewer. The object tracking process may track an object other than face, eye or other body part of the viewer-for example, the viewer may hold or wear a predetermined object (e.g. an object with known dimensions) that can be identified using the object processing, or the viewer may hold or wear the camera, and the object tracking process may identify the display screen 420 or the apparatus 400.

In some examples, the location information received by the communication circuitry 900 could be audio data, in which case the position-tracking circuitry 915 may comprise audio processing circuitry to process the audio data in order to determine the relative position of the user. For example, this could be based on sounds made by the viewer (e.g. speech—this might be particularly applicable when the display screen is being used for video calls, since the viewer is likely to be speaking when making a call—sounds made by the user may get louder as the user moves towards a microphone), or it could be based on other sounds (e.g. background sounds may be muffled or distorted depending on the user's position relative to the microphone).

Other examples of location information are also possible-for example, where the location-tracking device is a handheld or wearable device such as a smartphone or smartwatch, such a device may be capable of obtaining satellite location information and transmitting this to the communication circuitry 900. Such a device may also (or instead) comprise a gyroscope to detect motion of the device-the location information can, therefore, comprise gyroscope data.

The location-tracking device 910 and the display screen 420 are shown, in FIG. 9, as being separate from the apparatus for holding the display screen. The communication circuitry 900 may be arranged to communicate with these devices through wired communication or wireless communication. However, in other examples, one or both of the display screen 430 and the location-tracking device could be integrated with the apparatus.

The apparatus 400 also includes viewing-region-checking circuitry 930. The viewing-region-checking circuitry 930 receives information about the relative position of the user (e.g. from the position-tracking circuitry 915), and uses this to determine whether the user is within the predetermined viewing region. For example, this determination could be made with reference to information about the predetermined viewing region stored in storage circuitry 935 of the apparatus 400. Hence, the viewing-region-checking circuitry 930 is an example of viewing-region-checking circuitry to determine whether the relative position of the viewer is within a predetermined viewing region.

Based on the determination by the viewing-region-checking circuitry 930, adjustment control circuitry 940 generates control information to be sent, by the communication circuitry 900, to the adjustment circuitry 905. This control information is for controlling the adjustment circuitry 905 to adjust the position and/or orientation of the display screen 420, and is generated-in dependence on the determination made by the viewing-region-checking circuitry-such that the adjustment circuitry 905 is controlled to adjust the position and/or orientation of the display screen in such a way that the viewer remains within the predetermined viewing region. Hence, the adjustment control circuitry 940 is an example of adjustment control circuitry responsive to the viewing-region-checking circuitry determining that the relative position of the viewer is outside of the predetermined viewing region to control adjustment circuitry to adjust the position and/or orientation of the display screen to place the relative position of the viewer in the predetermined viewing region.

Accordingly, the apparatus 400 is able to keep a viewer within the predetermined viewing region (the sweet spot) as they move, hence improving the experience for the viewer.

Note that, although the position-tracking circuitry 915, viewing-region-checking circuitry 930 and adjustment control circuitry 940 are shown in FIG. 9 as separate elements, it is also possible for a single processing element to provide the functionality of multiple of these circuits. For example, the apparatus 400 may comprise a central processing unit (CPU) 925 which may provide at least some of the functionality of one or more of these circuits. The apparatus 400 may also comprise a graphics processing unit (GPU) 920 to perform image processing and which may provide at least some of the functionality of the position-tracking circuitry 915.

The display screen 420 may be a 3D display screen such as a spatial reality display screen, or it may be a 2D display screen. If the display screen is a 2D display screen, the apparatus 400 can still be useful, since it can allow a viewer to move further around the screen while still being able to view a displayed image. However, the apparatus 400 is particularly advantageous for a 3D display screen, since it can help to enhance and/or maintain the 3D effect.

A particular use for the apparatus 400 may be to provide more convincing augmented reality. For example, the apparatus 400 may comprise a camera to capture one or more images (this camera may or may not be same as the location-tracking device), and image processing circuitry to generate, based on the one or more images, a display image representing surroundings of the system. For example, the display image may represent the view the viewer would see if the display screen was not present. The image processing circuitry can then adapt the display image in response to the adjustment control circuitry controlling the adjustment circuitry to adjust the position and/or orientation of the display screen. This allows the image to be adjusted to compensate not just for the viewer's movement (as in the case of a spatial reality display screen, for example) but also in response to the movement of the display screen itself. This can be used to implement augmented reality effects such as invisibility cloaking, where the image displayed on the screen makes an object in the room appear invisible.

### Method and Program

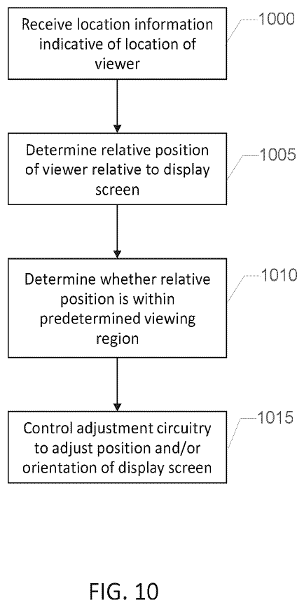

FIG. 10 is a flow diagram illustrating an example of a method for operating an apparatus for holding a display screen. The method comprises: receiving 1000, from at least one location-tracking device, location information indicative of a location of a viewer; determining 1005, in response to the location information, a relative position of the viewer relative to the display screen; determining 1010 whether the relative position of the viewer is within a predetermined viewing region; and controlling 1015, in response to a determination that the relative position of the viewer is outside of the predetermined viewing region, adjustment circuitry to adjust the position and/or orientation of the display screen to place the relative position of the viewer in the predetermined viewing region.

The method of FIG. 10 may be performed by an apparatus such as the apparatus 400 shown in FIGS. 4 to 9. For example, step 1000 may be performed by the communication circuitry 900, step 1005 may be performed by the position-tracking circuitry 915, step 1010 may be performed by the viewing-region-checking circuitry 930 and step 1015 may be performed by the adjustment control circuitry 940.

Methods of the present technique may also be implemented by a computer program. For example, the computer program may comprise a number of instructions which, when executed by a computer, cause the computer to perform the methods. The computer program, which may be stored on a transitory or non-transitory computer-readable storage medium, thus provides all of the advantages of the methods described above.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. An apparatus for holding a display screen, the apparatus comprising:
reception circuitry to receive, from at least one location-tracking device, location information indicative of a location of a viewer;
position-tracking circuitry responsive to the location information to determine a relative position of the viewer relative to the display screen;
viewing-region-checking circuitry to determine whether the relative position of the viewer is within a predetermined viewing region; and
adjustment control circuitry responsive to the viewing-region-checking circuitry determining that the relative position of the viewer is outside of the predetermined viewing region to control adjustment circuitry to adjust the position and/or orientation of the display screen to place the relative position of the viewer in the predetermined viewing region.

2. The apparatus of claim 1, wherein the predetermined viewing region comprises a region within which an image displayed on the screen satisfies a given condition when viewed by the viewer positioned in the predetermined viewing region.

3. The apparatus of claim 1, wherein the predetermined viewing region comprises a region within which the at least one location-tracking device is capable of tracking the viewer.

4. The apparatus of claim 1, comprising
the adjustment circuitry,
wherein the adjustment circuitry comprises at least one of:
rotation circuitry to adjust the orientation of the display screen by rotating the display screen about one or more axes of rotation; and
translation circuitry to adjust the position of the display screen.

5. The apparatus of claim 1, wherein:
the reception circuitry is configured to receive, as the location information, image data captured by at least one camera; and
the position-tracking circuitry comprises image recognition circuitry to determine, based on the image data, the relative position of the viewer.

6. The apparatus of claim 5, wherein: the object recognition process comprises a facial recognition process and the identified object comprises at least one of an object identified as a face and an object identified as an eye.

7. The apparatus of claim 1, wherein:
the reception circuitry is configured to receive, as the location information, audio data recorded by the at least one microphone; and
the position-tracking circuitry comprises audio processing circuitry to determine, based on the audio data, the relative position of the viewer.

8. The apparatus of claim 1, wherein the reception circuitry is configured to receive the location information from at least one handheld and/or wearable device.

9. The apparatus of claim 1, comprising the location-tracking device.

10. The apparatus of claim 1, comprising the display screen.

11. The apparatus of claim 10, wherein the display screen comprises one of: a 3D display screen; and a spatial reality display screen.

12. The apparatus of claim 2, in which the given condition is one of:
i. a 3D effect is visible;
ii. a parallax effect is visible; and
iii. the displayed image is visible.

13. The apparatus of claim 9, comprising:
a camera to capture one or more images; and
image processing circuitry to generate, based on the one or more images, a display image representing surroundings of the system, and to adapt, in response to the adjustment control circuitry controlling the adjustment circuitry to adjust the position and/or orientation of the display screen, the display image.

14. A method of operating an apparatus for holding a display screen, the method comprising:
receiving, from at least one location-tracking device, location information indicative of a location of a viewer;
determining, in response to the location information, a relative position of the viewer relative to the display screen;
determining whether the relative position of the viewer is within a predetermined viewing region; and
controlling, in response to a determination that the relative position of the viewer is outside of the predetermined viewing region, adjustment circuitry to adjust the position and/or orientation of the display screen to place the relative position of the viewer in the predetermined viewing region.

15. A non-transitory, computer readable storage medium containing a computer program comprising instructions which, when executed on a computer, cause the computer to perform a method of operating an apparatus for holding a display screen, the method comprising:
receiving, from at least one location-tracking device, location information indicative of a location of a viewer;
determining, in response to the location information, a relative position of the viewer relative to the display screen;
determining whether the relative position of the viewer is within a predetermined viewing region; and
controlling, in response to a determination that the relative position of the viewer is outside of the predetermined viewing region, adjustment circuitry to adjust the position and/or orientation of the display screen to place the relative position of the viewer in the predetermined viewing region.
